(19) United States
(12) Patent Application Publication
(10) Pub. No.: US 2017/0215454 A1
(43) Pub. Date: Aug. 3, 2017

(54) AERATED CONFECTION AND PROCESS FOR MAKING

(71) Applicant: WM. WRIGLEY JR. COMPANY, Chicago, IL (US)

(72) Inventors: Joo Song, Honolulu, HI (US); April J. Tackett, Chicago, IL (US); Scott G. Brown, Oswego, IL (US)

(21) Appl. No.: 15/501,351

(22) PCT Filed: Aug. 7, 2015
(86) PCT No.: PCT/US15/44369

§ 371 Date: Feb. 2, 2017

Related U.S. Application Data
(60) Provisional application No. 62/035,004, filed on Aug. 8, 2014.

(51) Int. Cl. A23G 3/52; A23G 3/34; A23G 3/42; A23G 3/40

(52) U.S. Cl. CPC A23G 3/52; A23G 3/40; A23G 3/0012; A23G 3/42; A23V 2002/00

(57) ABSTRACT

A product invention that relates to an aerated confection containing a texture modifier and a saccharide mass, that comprises a backbone saccharide, a stability saccharide, and optionally a lubricant saccharide. The saccharides are chosen such that the saccharides will have a fluid molten structure that will create a stable aerated mass after extrusion with carbon dioxide. The texture modifier is added to vary the texture of the aerated confection, including making the hard confection chewy thereby extending the consumer's enjoyment of the confection. The invention also relates to the method of making the stable aerated confections with extrusion processing using super critical carbon dioxide.

### FIELD OF THE INVENTION

The present invention relates to an aerated saccharide based confection. The present invention also relates to a confection manufacturing process with an aeration step, where the aeration process uses super critical carbon dioxide to create products with a firm first bite and a cohesive chewing texture.

### BACKGROUND OF THE INVENTION

Aerated confections, such as malted milk balls, are popular with consumers, because they are “crunchy” and they deliver sweetness and flavor at a caloric content less per confection piece than other confections of the same piece volume, such as caramels and taffies. Currently, available aerated confections that are crunchy, can have negative eating characteristics such as being too hard on first bite and too powdery in mouthfeel when chewed. A hard confection can be characterized as being crunchy if the confection is also brittle. When a confection is “crunchy”, the consumer can feel and hear the sound of the brittle confection breaking up into small pieces as it is chewed. The more brittle the hard confection is, the smaller the resulting broken pieces will be. If the small pieces of broken-up confection are not immediately dissolved in saliva, the small pieces can create a powdery mouthfeel during chewing.

Aerated confections are expensive to manufacture relative to nonaerated confections due to the need to add water to the confection mass, and then to remove the water from the confection mass, as well as the need to aerate the confection mass. These processes include heating under vacuum. Many aerated confection processes also include a post aeration heating process step to solidify the aerated mass in order to stabilize the aerated structure.

Consumers like aerated confections because their low density that results in a greater number of confection pieces per serving, which creates a longer eating experience at a relatively lower caloric content. It is desirable to consumers to make such aerated confections with a crunchy texture, a less hard first bite, and a less powdery mouthfeel when chewed than traditional aerated confections (such as malted milk balls). It is desired by confection manufacturers to reduce energy requirements in confection production processes. This includes looking into reducing the energy required in all process steps needed to make the final finished confections.

### SUMMARY OF THE INVENTION

An aerated confection can be produced containing a texture modifier and a saccharide mass, which comprises a backbone saccharide and a stability saccharide. These ingredients are chosen such that the resulting confection mass will have a fluid molten structure that will mix with super critical carbon dioxide, and then aerate (i.e., expand) as the super critical carbon dioxide gasifies. These ingredients are also chosen such that the resulting aerated ingredient mass retains its aerated structure at ambient room temperature and atmosphere without additional heating for water evaporation or ingredient denaturation. The texture modifier is included in the confection to soften the first bite hardness and to create a less powdery, more cohesive, chewing mouthfeel; thereby increasing the consumer's enjoyment of the crunchy aerated confection. The invention also relates to the method of making the stable aerated confections with extrusion processing using super critical carbon dioxide at a total process energy reduced over the energy required to make aerated confections using vacuum processing. By providing an aerated confection having a crunchy texture and less hard first bite with a less powdery mouthfeel that uses less energy to produce, the invention meets the needs of both consumers and confection manufacturers, respectively.

### DETAILED DESCRIPTION OF THE INVENTION

The present invention relates to a firm aerated confection. Preferably, the aerated confection includes backbone and stability saccharides, and a texture modifier. Optionally, the confection mass also includes a lubricant. The confection mass includes no added water. The confection ingredients, including the texture modifier, are chosen such that the final aerated confection has a crunchy texture with a firm first bite and a cohesive, non-powdery texture during chewing (i.e., mastication). The confection mass can further comprise additional ingredients such as, but not limited to, colors, flavors, high intensity sweeteners (HIS), sensates, actives and combinations thereof. The confection mass may be finished with dry powder ingredients, fluid ingredients, soft confectionary materials, pan coating, or combination thereof.

The aerated confection of this invention includes embodiments that can be described as “dry foams”. Dry foams have aerated, firm, and spatially open structures that contain less than 8 wt. % water. When used to describe a dry foam confection, “firm” means that the confection piece has a rigid texture at room temperature (i.e., 22-27 C), that is, it maintains its shape at room temperature. An aerated confection texture can be described as firm and crunchy if there is resistance to deformation of the confection during first bite, and the confection mass is brittle enough to break into many smaller pieces during chewing.

Backbone and Stability Saccharides:

The confection mass of various embodiments of this invention are comprised of at least one backbone saccharide and at least one stability saccharide. The backbone and stability saccharides are complex and simple saccharides chosen using their T_{g}, Tₘ, and degree of hygroscopicity, so that the result is a fluid confection mass that will mix with super critical carbon dioxide, expand as the super critical carbon dioxide gasifies (i.e., changes from fluid to gas), and remain expanded as the super critical carbon dioxide leaves the confection mass. Additionally, the aerated confection remains expanded after the confection mass reaches ambient temperature and atmosphere.

A backbone saccharide is a complex saccharide in which fluid super critical carbon dioxide is soluble. When mixed under pressure at a temperature high enough to melt the backbone saccharide, the fluid carbon dioxide will spread throughout the melted backbone saccharide mass. When that combined mass is then brought to ambient temperature and atmosphere, the carbon dioxide will expand as it turns into gas. The backbone saccharide surrounding the carbon dioxide will likewise aerate (i.e., expand) without need of an elastic ingredient. The backbone saccharide can be chosen from the non-limiting group of polyglycitol, polydextrose, and corn syrup solids. The viscosity of the heated confection mass containing the backbone saccharide would be low enough for the confection mass to be conveyed through a pressurized apparatus with mixing and heating capabilities (e.g., extruder) and then out of the apparatus through an exit opening (e.g., die plate). Note that there is no water added to the confection mass to aid in controlling confection mass viscosity. The confection mass containing only the backbone saccharide would be too soft and fluid in texture after leaving the apparatus to have the body necessary to hold a form. Because this occurs, a stability saccharide is added to the confection mass. Also, the confection mass would not stay expanded after leaving the apparatus, without a stability saccharide in the confection mass.

A stability saccharide is a simple saccharide that has a melting point (Tₘ) below that of the maximum heating temperature applied to a confection mass. The maximum heating temperature is high enough to melt the backbone saccharide. The stability saccharide is chosen so that it will remain in crystal form throughout the melting of the backbone saccharide. If the confection mass is heated over the melting point of the stability saccharide, then the stability saccharide is still able to stabilize the backbone aerated structure as the stability saccharide will crystallize before the background saccharide as the heated confection mass cools. Examples of saccharides that could be used as stability saccharides are selected from the non-limiting group including sucrose, dextrose, maltose, fructose, erythritol, mannitol, maltitol, isomalt, sorbitol, xylitol, and combinations thereof. The addition of a stability saccharide to a confection mass containing a backbone saccharide will reduce the molten confection mass viscosity and stabilize the aerated confection structure at ambient temperature (i.e., 22-27 C) and atmosphere. The stability saccharides physically impede the aerated backbone saccharide from contracting as the pressure of the expanding carbon dioxide gas disappears at ambient temperature and atmosphere. Additionally, the stability saccharide, being crystal in form, also aides in creating a firm and crunchy texture in the final aerated confection.

Saccharide Solid and Fluid Properties:

Saccharides vary greatly in their structures and in their solid and fluid properties. Table 1 gives a non-limiting list of various saccharides that can be used to make aerated confections. Simple saccharides contain one to three sugar or hydrogenated sugar (i.e., polyol) units and have low molecular weights. Because of their molecular composition, simple saccharides can create crystal structures. Complex saccharides have more than three, often hundreds, of simple saccharide units. These complex saccharides are less likely to crystallize due to physical difficulties in aligning their parts into organized crystal forms. Polydextrose is a synthetic polymer of dextrose units. Polydextrose is commonly used in sugar and sugar-free products, because it contains sugar units and it has a low caloric value due to being difficult to digest. Corn syrup solids are produced by enzymatically and/or chemically degrading starch into various lengths of saccharides. Some of the resulting saccharides are simple saccharides, though most are very large complex saccharides. Polyglycitol (also called hydrogenated starch hydrolysate) is produced by hydrogenating mixtures of sugars, maltodextrins, and/or corn syrup. Polyglycitol contains some simple polyols, though mostly long chain polyols.

TABLE 1
Table 1: Saccharides and Their Molecular
Weight, Tₘ, T_{g}, Degree of Hygroscopicity

| | Molecular | | | Degree of |
|---|---|---|---|---|
| | Weight | Tₘ | T_{g} | Hygro- |
| Saccharide | (daltons) | (° C.) | (° C.) | scopicity |
| Fructose | 180 | 105 | −42 | High |
| Dextrose | 180 | 146 | −43 | Low |
| Sucrose | 342 | 179-186 | −32 | Low |
| Starch | 200-4,000 | UK | 243 | Low |
| (approximate) | | | | |
| Corn Syrup Solids | 200-4,000 | UK | 80 | Medium |
| Polydextrose | 250->22,000 | amorphous | 120-120 | High |
| Erythritol | 122 | 121 | −42 | Very Low |
| Xylitol | 152 | 92-96 | −29 | High |
| Sorbitol | 182 | 99-101 | −9 | Medium |
| Mannitol | 182 | 165-169 | 13 | Very Low |
| Isomalt | 344 | 145-150 | 64 | Very Low |
| Maltitol | 344 | 144-147 | 39 | Low |
| Polyglycitol | 1,000-3,600 | 173-179 | UK | Medium |
| Carnauba Wax | | 82-86 | | |

UK = unknown

The physical properties of saccharides are dependent on their molecular weight (Mw), crystal melt temperature (Tₘ), glass transition temperature (T_{g}), and degree of hygroscopicity. The molecular weight is the physical weight of the molecules in daltons. The melting temperature (Tₘ) is the temperature at which saccharide crystals will melt. Molten saccharides will recrystallize at roughly the same temperature at which they melt. In a confection, stability saccharides remain in crystal form while the backbone saccharide melts as the confection mass is heated; that is, the Tₘ of the stability saccharide is greater than the Tₘ of the backbone saccharide. If the confection is further heated to above their melting temperature, the stability saccharides will also melt. If this same heated confection is then reduced in temperature, then the stability saccharides will crystallize before the backbone saccharides.

The glass transition temperature (T_{g}) is the temperature at which melted and/or amorphous saccharides will transition from fluid to solid physical state as the saccharide mass is cooled, or will transition from solid to fluid as the saccharide mass is heated. The fluid character can be measured in terms of its viscosity. In embodiments of this invention, the T_{g} of the stability saccharide is less than the T_{g} of the backbone saccharide. The stability and backbone saccharides are chosen such that the melted stability saccharide is more fluid (i.e., lower viscosity) than the backbone saccharide.

The degree of hygroscopicity of a saccharide is the tendency of a saccharide to absorb ambient moisture. The greater the tendency for the saccharide to absorb moisture, the stickier the saccharide can be both in its crystalline and melted forms. The longer and the more branched the saccharide molecule, the greater the molecule's degree of hygroscopicity. The moisture absorbed by a confection with saccharides that have a high degree of hygroscopicity will dissolve some of the simple saccharides that contact with the moisture. The absorption usually occurs on the surface of confections, resulting in a tacky confection surface. Also, if the stability saccharides are dissolved in absorbed moisture, they are unavailable to stabilize the aerated backbone saccharide structure from contracting (i.e., shrinking).

Texture Modifiers:

Texture modifiers are ingredients that are added to a confection mass containing a saccharide mass to modify the texture of the finished product, such as softening the hardness of a finished aerated confection and reducing the powdery mouthfeel while creating cohesiveness of the confection mass when the confection is chewed. Texture modifiers include, but are not limited to, complex saccharides (such as, but not limited to, maltodextrin, modified starch, and inulin), proteins (such as, but not limited to, whey protein isolate and gelatin), and hydrocolloids (such as, but not limited to, pectin, carrageenan, and xanthan gum). The texture modifier may also comprise noncrystallizing saccharide syrup solids that are combinations of saccharides in a stable amorphous dry form. The texture modifiers have a high degree of hygroscopicity that would allow the confection containing the texture modifiers to absorb moisture during chewing that then creates a cohesive agglomeration of broken confection pieces during chewing. This ability to create a cohesive mass eliminates the powdery mouthfeel during chewing. The amount of texture modifier is balanced with the amounts of backbone and stability saccharide in the confection mass so that ideal product texture is reached. Too little texture modifier and the finished confection will have a too hard first bite and a powdery mouthfeel when chewed. Too much texture modifier and the finished confection will have too soft a texture to be crunchy. Additionally, inclusion of texture modifier slows the firming of the confection mass so that the aerated mass exiting the mixing and heating apparatus (e.g., extruder) is malleable enough to be further finished. Finishing includes, but is not limited to, embossing, pressing, dusting with dry ingredients, spraying with liquid ingredients, coating with soft confectionary material (such as, but not limited to, chocolate, compound coating, or chewy grained candy), pan coating, or combinations thereof.

Lubricant:

A lubricant may be included in a confection mass containing a backbone saccharide and a stability saccharide to reduce the energy needed to mix, melt, and convey the confection mass though the pressurized mixing and melting apparatus (e.g., extruder). Non-limiting examples of saccharides that could be used as lubricants are selected from the non-limiting group including sucrose, dextrose, maltose, fructose, erythritol, mannitol, maltitol, isomalt, sorbitol, xylitol, and combinations thereof. The preferred lubricant saccharide has a Tₘ less than that of the backbone saccharide so that the lubricant will be melted before the backbone saccharide. Also, the preferred lubricant saccharide would have a T_{g} less than that of the backbone so that the lubricant is more fluid (i.e., has lower viscosity) than the backbone saccharide. These characteristics allow the lubricant saccharide to become fluid early in the melting stage of the production process, and to mix with the not yet melted backbone saccharide, which allows better flow of the total confection mass through the pressurized mixing and melting apparatus. The melted lubricant saccharide will also mix with any other ingredients (such as texture modifiers, flavors, colors, HIS, sensates, actives, and combinations thereof) added to the saccharide mass and will aid in dispersing those added ingredients throughout the total mass.

Non-saccharide lubricants, such as, but not limited to wax and fat, are often included in a confection mass containing a backbone saccharide and a stability saccharide for several reasons, including: 1) to reduce the friction between the confection mass and the pressurized mixing and heating apparatus and otherwise reducing the viscosity of the confection mass while in the apparatus; 2) to create an appealing shiny confection surface appearance post aeration; 3) to reduce shear caused by the confection mass flowing over edges of apparatus exit opening (e.g., die plate opening); and 4) to reduce confection surface ambient moisture absorption post-aeration.

The non-saccharide lubricants are hydrophobic and migrate to the surface of the mass being mixed and melted. This creates a protective lubricant layer on the surface of the extruded mass as the mass is conveyed through and out of the apparatus. The non-saccharide lubricants also add fluidity to the confection mass in the apparatus during mixing when the mass is heated above the melting point of the non-saccharide lubricant.

Aeration Process:

The method of confection aeration used in embodiments of this invention is aeration through pressurized heating and mixing with super critical carbon dioxide. Supercritical carbon dioxide is carbon dioxide in a fluid state when it is held at, or above, its critical temperature (31° C.) and pressure (73 atm.). In this fluid state, carbon dioxide is between a gas and a liquid. The confection aeration process involves mixing fluid confection mass with super critical carbon dioxide under elevated temperatures and pressure, and then releasing the pressure and reducing the temperature, which then causes the confection mass to aerate as the carbon dioxide expands and then dissipates from the confection mass. The saccharide mass of the confection (that is the backbone and stability saccharides) prevent the aerated confection mass from returning to its pre-aeration volume.

The amount of aeration of a product, that is the volume of the aerated product, can be described as the product's envelope density. The envelope density is a measure of the aeration of an aerated confection piece that takes into account both full piece volume and interior air cell volume.

The envelope density of a confection can be measured using a “granular sugar displacement method”, containing the steps of: 1) tare a 25 ml glass graduated cylinder; 2) weigh out 5 confection pieces in the tared graduated cylinder on a weight scale; 3) fill the graduated cylinder carefully with dry granular sugar until all 5 pieces are covered with sugar; 4) tap the cylinder with 5 pieces and granular sugar 10 times on padded table top; 5) adjust the sugar fill volume to cylinder's 25 ml mark; 6) remove the contents from the cylinder and then carefully separate sugar from pieces; 7) return the granular sugar contents back to the cylinder; 8) record the volume (volume less than 25 ml, measured in ml) of the granular sugar contents from cylinder markings; and 9) calculate the confection piece envelope density: Mass of 5 confection pieces (grams)÷ Volume in cylinder difference between with and without 5 pieces=Envelope density in g/ml.

A confection that has an envelope density less than 1 g/ml is considered aerated. The aerated confections of this invention have an envelope density of less than or equal to 0.8 g/ml.

The process steps for creating a crunchy aerated confection using super critical carbon dioxide, include: 1) mixing and heating in a pressurized apparatus (e.g., extruder) a confection mass comprising at least one backbone saccharide, at least one stability saccharide, a texture modifier, and optionally a lubricant; 2) mixing into that confection mass carbon dioxide under super critical pressure and temperature; 3) forcing the mixed mass out of the apparatus through an exit opening (e.g., die plate); 4) forming a rope, ribbon, or sheet of the mass as it leaves the apparatus and it aerates (i.e., expands) under ambient atmosphere and temperature; and 5) shaping the aerated confection mass, such as, but not limited to, cutting the mass into individual pieces. This process could further include introducing into the apparatus, before or after carbon dioxide is mixed with the heated confection mass, additional ingredients including, but not limited to, lubricants, high intensity sweeteners (HIS), colors, acids, actives, flavors, sensates and combinations thereof. Additionally, this process could include finishing the aerated confection by pressing, embossing, dusting with dry ingredients, spraying with liquid ingredients, coating with soft confectionary materials (such as, but not limited to chocolate, compound coating, grained chewy candy, and combinations thereof), pan coating, or combinations thereof. Note that this process does not include a process step to evaporate water and/or to purposely denature ingredients in order to maintain expanded confection structure.

In an embodiment of this invention, an aerated confection comprises a saccharide mass, which comprises a backbone saccharide and a stability saccharide, wherein the Tₘ of the stability saccharide is higher than the Tₘ of backbone saccharide.

In an embodiment of this invention, an aerated confection comprises a texture modifier, and a saccharide mass, which comprises a backbone saccharide and a stability saccharide, wherein the Tₘ of the stability saccharide is higher than the Tₘ of backbone saccharide. A lubricant can be further included in this confection.

In an embodiment of this invention, an aerated confection comprises a texture modifier; additional ingredients such as, but not limited to, wax, fat, color, flavor, high intensity sweetener, sensate, actives and combinations thereof; and a saccharide mass, which comprises a backbone saccharide, a stability saccharide, and optionally a lubricant saccharide.

In an embodiment of this invention, an aerated confection comprises a texture modifier; additional ingredients such as, but not limited to, wax, fat, color, flavor, high intensity sweetener, sensate, actives and combinations thereof; and a saccharide mass, which comprises a backbone saccharide and a stability saccharide, wherein the Tₘ of the stability saccharide is higher than the Tₘ of backbone saccharide. In further embodiment of this invention, the aerated confection contains a lubricant with a T_{g} less than the T_{g} of the backbone saccharide.

In an embodiment of this invention, an aerated confection comprises about 6-10 wt. % modified corn starch and maltodextrin; about 0.2-1 wt. % colors, acid, flavor, and HIS; and about 0.5-2 wt. % carnauba wax; and about 93-87 wt. % saccharide mass, which comprises about 40-55 wt. % corn syrup solids; about 50-40 wt. % sucrose and dextrose.

In an embodiment of this invention, an aerated confection comprises about 3-10 wt. % inulin; about 0.2-1 wt. % colors, acid, flavor, and HIS; and about 0.5-2 wt. % carnauba wax; and about 96-87 wt. % saccharide mass, which comprises about 80-90 wt. % polydextrose and/or polyglycitol; and about 3-8 wt. % sorbitol.

In an embodiment of this invention, an aerated confection comprises about 3-35 wt. % texture modifier; and about 97-65 wt. % saccharide mass, which comprises about 20-90 wt. % backbone saccharides with Tₘ less than 140 C; about 80-10 wt. % stability saccharides with Tₘ less than 120 C; and optionally about 20 wt. % lubricant saccharide with T_{g} less than the T_{g} of the backbone saccharide; wherein the aerated confection product has an envelope density of less than 0.8 g/ml.

In an embodiment of this invention, an aerated confection comprises about 10-15 wt. % modified starch; and about 90-85 wt. % saccharide mass, which comprises about 20-40 wt. % polydextrose; and about 35-60 wt. % dextrose, fructose, or combination thereof.

In an embodiment of this invention, an aerated confection comprises about 3-10 wt. % modified starch; about 0.02-2 wt. % flavor; and about 97-88 wt. % saccharide mass, which comprises about 40-60 wt. % polydextrose; and about 30-70 wt. % dextrose, fructose, or combination thereof.

In an embodiment of this invention, an aerated confection comprises up to about 40 wt. % texture modifier selected from the group comprising inulin, modified starch, maltodextrin, and combination thereof; and up to about 100 wt. % saccharide mass, which comprises up to about 90 wt. % polydextrose, corn syrup solids or combination thereof; and up to about 40 wt. % stability saccharide selected from the group comprising sucrose, dextrose, fructose, and combination thereof.

In an embodiment of this invention, an aerated confection comprises up to about 40 wt. % texture modifier; and up to about 100 wt. % saccharide mass, which comprises up to about 70 wt. % polyglycitol; and up to about 40 wt. % stability saccharide selected from the group comprising sorbitol, isomalt, and combination thereof.

In an embodiment of this invention, an aerated confection comprises a texture modifier; additional ingredients such as, but not limited to, wax, fat, color, flavor, high intensity sweetener, sensate, actives and combinations thereof; and a saccharide mass, which comprises a backbone saccharide and a stability saccharide; wherein the Tₘ of the stability saccharide is higher than the Tₘ of backbone saccharide, and wherein up to about 70 wt. %, up to about 60 wt. %, up to about 50 wt. %, up to about 40 wt. %, up to about 30 wt. %, or up to about 20 wt. % of saccharide mass is in crystal form at room temperature.

In an embodiment of this invention, an aerated confection comprises a texture modifier; and a saccharide mass, which comprises a backbone saccharide, and a stability saccharide; wherein up to about 70 wt. %, up to about 60 wt. %, up to about 50 wt. %, up to about 40 wt. %, up to about 30 wt. %, or up to about 20 wt. % of saccharide mass is in crystal form at room temperature.

In an embodiment of this invention, an aerated confection comprises about 3-40 wt. % maltodextrin; about 0.5-2 wt. % carnauba wax, about 0.5-3 wt. % flavors and colors; and about 96-55 wt. % saccharide mass, which comprises about 50-90 wt. % polydextrose; and about 50-10 wt. % sorbitol.

In an embodiment of this invention, an aerated confection comprises about 3-35 wt. % whey protein isolate; and about 97-65 wt. % saccharide mass, which comprises about 20-90 wt. % with Tₘ less than 140° C.; about 80-10 wt. % dextrose with Tₘ less than 120° C.; and about 20 wt. % erythritol with T_{g} less than the T_{g} of the backbone saccharide.

In an embodiment of this invention, an aerated confection comprises a texture modifier selected from the group comprising of proteins, modified starches, maltodextrins, hydrocolloids, inulin, noncrystallizing saccharide syrup solids, and combinations thereof; additional ingredients such as, but not limited to, wax, fat, color, flavor, high intensity sweetener, sensate, actives and combinations thereof; and a saccharide mass, which comprises a backbone saccharide selected from the group consisting of polydextrose, polyglycitol, corn syrup solids, and combinations thereof; a stability saccharide selected from the group consisting of sucrose, dextrose, maltose, fructose, erythritol, mannitol, maltitol, isomalt, sorbitol, xylitol and combinations thereof, and optionally a lubricant selected from the group consisting of wax, fat, sucrose, dextrose, fructose, erythritol, mannitol, maltitol, isomalt, sorbitol, xylitol and combinations thereof. In a further embodiment, the aerated confection further comprises a surface coating selected from the group consisting of dry powder ingredients, liquid ingredients, soft confectionary mass (such as, but not limited to chocolate, compound coating, grained chewy confection, and combinations thereof), pan coating, or combinations thereof.

In an embodiment of this invention, a process for making an aerated confection, comprising the steps of: 1) introducing a confection mass containing at least one texture modifier, at least one backbone saccharide, at least one stability saccharide, and optionally additional ingredients selected from the group consisting of wax, fat, color, flavor, high intensity sweeteners, sensates, actives and combinations thereof into a pressurized apparatus with mixing and heating capabilities (e.g., extruder); 2) mixing and heating the confection mass in the extruder to a temperature where all backbone saccharides are melted and fluid and little or no stability saccharide crystals are melted; 3) introducing super critical carbon dioxide into the extruder under high pressure conditions; 4) mixing the carbon dioxide into the heated confection mass; 5) forcing the combined confection mass and carbon dioxide through an exit opening in the apparatus (e.g., die plate opening); 6) aerating the confection mass as it passes from the high pressure in the apparatus to the ambient atmospheric temperature and pressure outside the apparatus; 7) forming the aerated confection mass into a rope, ribbon, or sheet form by passage through an exit opening in the apparatus; and 8) shaping (e.g., cutting) the confection mass into individual pieces. In a further embodiment of this invention, the process for making an aerated confection further includes the step of finishing the shaped pieces by pressing, embossing, dusting with dry ingredients, spraying with liquid ingredients, coating with soft confectionary material (including, but not limited to, chocolate, compound coating, grained chewy candy or combinations thereof), pan coating or combinations thereof.

### Examples

Several confection samples were made with formulas containing various backbone saccharides and stability saccharides, and optionally including lubricants, and texture modifiers.

Table 2 includes confection formulas with polydextrose backbone.

TABLE 2
Formulas with Polydextrose (wt. %)

| | 1 | 2 |
|---|---|---|
| Polydextrose | 50-90 | 20-40 |
| Sorbitol | 0-20 | |
| Carnauba Wax | 0-2 | |
| Dextrose | | 30-50 |
| Modified Starch | | 10-15 |
| Fructose | | 5-10 |
| Maltodextrin | 0-40 | |
| Confection Character = | Aerated & | Aerated, |
| | Hard | Cohesive |
| | | & Firm |

Table 2 gives ingredient ranges of formulas that were used to make aerated confections using super critical carbon dioxide. Note that confections produced with formulas containing ingredients falling within the ranges in column 1 did aerate. The resulting products were hard and crunchy. The backbone saccharide was polydextrose. The maltodextrin, being a long chain saccharide could also have acted as a texture modifier, but its amount in the formula did not noticeably soften the hardness of the first bite, nor make the confection cohesive when chewed. The sorbitol was the stability saccharide as the saccharide mass was heated to a temperature low enough to keep sorbitol in its crystal form. The amount of crystalline sorbitol could have overpowered the softening of the confection texture by maltodextrin, or the backbone saccharide (polydextrose). The addition of carnauba wax decreased the energy required to mix the formula mass as it made the confection mass more fluid in the extruder. Polydextrose has a tendency to mesh with itself and create high viscosities in the extruder.

Confections produced with ingredients falling within the ranges in column 2 of Table 2 also aerated, but had a less powdery, chewier and less hard and brittle texture when chewed than the confections made under column 1. The confections made with formulas with ingredients falling within column 2 created a more cohesive, and so chewier, texture when chewed than formulas with ingredients within column 1. Formulas with texture modifiers absorbed saliva and created a more cohesive chewing mass than formulas without texture modifiers. Polydextrose would again be the backbone saccharide and is itself very hygroscopic, which aided in creating a non-powdery, cohesive, chewier aerated confection, though that was not polydextrose's primary function. The small molecular weight (and higher Tₘ) saccharides (e.g., dextrose and fructose) were stability saccharides in these formulas. To make a stable aerated confection, the heating temperature must be low enough for these simple saccharides to remain in their crystal form. Their crystal form aided in stabilizing the stretched fluid polydextrose, but did not overcome the plastic nature of polydextrose, as seen by the resulting product being more cohesive, chewier, and not as hard as other formulas.

Starch can have more than one role in an aerated confection. The role is determined by its physical structure. Modified starch is in the aerated confection masses of column 2 in Table 2. If the modified starch was in a form that had its branches extended, then the starch could have acted like other complex saccharides. But the modified starch in column 2 was entangled with itself as it was in a granular form, and because of that entanglement the starch acted like a stability saccharide by physically impeding the shrinkage (i.e., contraction) of the aerated backbone saccharide. As the confections made with the formulas that fell within this column were aerated, cohesive, and firm, the amount of granular starch used was not enough to overcome the flexibility and hygroscopicity of the polydextrose. Also, the formulas that would fall under column 2 had enough granular starch content, and enough dextrose in crystal form, that the aerated confections were stable, had a firm, crunchy, less hard first bite, and a cohesive mouthfeel during chewing.

Table 3 contains formulas produced with polydextrose, polyglycitol, or corn syrup solids as the backbone saccharide, along with various ingredients added to modify aerated product texture.

TABLE 3
(numbers are in wt. %)

| | 4 | 5 |
|---|---|---|
| Polydextrose | 60-90 | 40-60 |
| Sorbitol | 0-20 | |
| Isomalt | 0-20 | |
| Sucrose | 0-40 | |
| Carnauba wax | 0-3 | |
| Dextrose | 0-30 | 20-40 |
| Modified Starch | 0-6 | 3-10 |
| Fructose | 0-20 | 10-30 |
| Maltodextrin | 0-40 | |
| Inulin | 0-15 | |
| Polyglycitol | 0-70 | |
| Corn syrup solids | 0-60 | |
| Flavor | 0-0.5 | 0.02-2 |
| Confection character = | Aerated& | Aerated, |
| | Hard | Cohesive |
| | | & Firm |

Product made with ingredients in the ranges in column 4 produced aerated confections that were hard and brittle and were crunchy when chewed. They also produced a more powdery mouthfeel when chewed than did confections made with formulas with ingredient ranges given in column 5. Confections made with ingredients in the ranges in column 5 produced aerated confections, which were firm, and brittle, but their broken pieces mixed with saliva and agglomerated as they were chewed, giving an at least slightly chewy chewing texture. Note that the modified starch in columns 5 and 2 are higher than that in columns 3 and 4. The addition of modified starch levels in these confection masses affected the hardness and possible crystal content of the aerated confections containing them. Note that the formula wt. % range for polydextrose is lower in columns 5 and 2 than 1 and 4. Less backbone saccharide would require less stability saccharides to stabilize the extruded confection mass. Less backbone saccharide content also meant more texture modifiers. A balance was reached between the amount of backbone saccharide and various other saccharides that acted as both aerated structure stabilizers and as lubricants.

The addition of texture modifiers, such as whey protein isolate to the confection mass created different chewing experiences by affecting the character of the broken-up confection mass pieces during chewing, by increasing the cohesiveness of the saccharide mass during chewing by causing faster saliva moisture pick-up, and by increasing the speed of the confection mass dissolving. Whey protein isolate decreased aeration expansion at high wt. %, though lower wt. % whey protein isolate just softened the aerated confection structure (i.e., less firm first bite and cohesive mouthfeel during chewing) without preventing confection mass aeration.

Modified starch, as already noted, can also modify the texture of an aerated confection mass. Inulin, which is a complex saccharide, composed of many fructose units, can also act as a texture modifier and soften the texture of an aerated saccharide mix mass.

Table 4 gives ingredient ranges for more formulas, which produce aerated saccharide mass confections that were cohesive and firm or hard when chewed.

TABLE 4
(numbers are in wt. %)

| | 6 | 7 |
|---|---|---|
| Polydextrose | 60-90 | |
| Sorbitol | 0-20 | |
| Isomalt | 0-20 | |
| Sucrose | | 0-40 |
| Carnauba wax | 0-3 | 0-3 |
| Dextrose | | 0-30 |
| Modified Starch | 0-1.5 | 0-6 |
| Fructose | | 0-20 |
| Maltodextrin | | 0-40 |
| Inulin | 0-15 | |
| Polyglycitol | 0-70 | |
| Corn syrup solids | | 0-60 |
| | 0-0.5 | 0-0.5 |
| Confection character = | Aerated, | Aerated & |
| | Cohesive | Hard |
| | & Firm | |

Table 4 gives ingredient ranges of formulas that formed aerated confection products, even when additional ingredients, such as inulin and modified starch were present. The confections made with formulas with ingredients ranges in column 6 and 7, did not have levels of texture modifiers (e.g., inulin, maltodextrin) high enough to prevent aeration. The formulas that fell within column 6 that included texture modifiers (e.g., inulin) had a softer first bite and were more cohesive when chewed than formulas that fell within column 7. Being hygroscopic, when polydextrose and/or polyglycitol were used as backbone saccharides, they aided in the softening of first bite and cohesion character of the confections during chewing. Formulas that fell within column 6 that had no inulin, had no or low levels of polydextrose and/or polyglycitol, and/or had high levels of simple saccharides and/or modified starch, were harder in texture and more powdery in mouthfeel during chewing than other formulas that fell within column 6. Formulas that fell within column 7 were hard and brittle, with a powdery mouthfeel when chewed. Formulas that fell within column 7 had none of the preferred backbone molecules (e.g., polydextrose, polyglycitol, and corn syrup solids). These formulas had enough longer structured saccharides (e.g., maltodextrin) to create an aerated structure, and enough simple saccharides in crystal form to stabilize the aerated structure, but no ingredients to soften the structure, or to make the confection mass cohesive during chewing.

Confection samples were made for a consumer test to evaluate the chewing character created by several formulas.

Table 5 contains the formulas for four confection samples produced and tested with consumers.

TABLE 5
Formulas for Consumer Testing (numbers in wt. %)

Consumer Test Samples:

| | 2 | 3 | 4 | 5 |
|---|---|---|---|---|
| | wt. % | wt. % | wt. % | wt. % |
| Corn syrup solids | 50.00 | | 44.27 | |
| Polyglycitol | | 53.80 | | 53.94 |
| Polydextrose | | 33.72 | | 33.72 |
| Sucrose | 30.41 | | 37.56 | |
| Sorbitol | | 5.99 | | 5.99 |
| Dextrose | 8.59 | | 8.73 | |
| Inulin | | 5.00 | | 5.00 |
| Modified corn starch | 4.76 | | 3.39 | |
| Maltodextrin | 4.76 | | 4.84 | |
| Colors, acid, flavor, HIS | 0.53 | 0.49 | 0.24 | 0.35 |
| Carnauba wax | 0.95 | 1.00 | 0.97 | 1.00 |

Samples in Table 5 were made by adding the formula ingredients in dry form into the loading entrance of a twin screw extruder. The extruder was a Coperion ZSK25 co-rotating twin-screw extruder configured as follows: Length/Diameter=53. The extruder contained multiple temperature zones, with the maximum temperature set at 140° C.-165° C. The screws mixed the confection mass as the mass was heated and conveyed down the length of the pressurized extruder. After all of the backbone saccharides and any lubricating saccharides and/or wax were melted, supercritical carbon dioxide was injected under pressure into the mixing mass. The mass was then conveyed down the extruder length, to and through, the extruder die plate with a circular shaped opening. Upon exiting the die plate opening, the mass aerated as the carbon dioxide expanded with the pressure decrease to ambient atmosphere. The aerated rope was then cut into individual pieces, finished, and packaged.

Consumers ate the aerated confection samples without knowing their contents. The resulting aerated confection samples were perceived as having firm, brittle, and crunchy textures. Samples with maltodextrin or inulin were less powdery when chewed than samples without these ingredients.

The compositions and methods of the present invention are capable of being incorporated in the form of a variety of embodiments, only a few of which have been illustrated and described. The invention may be embodied in other forms without departing from its spirit or essential characteristics. The described embodiments are to be considered in all respects only as illustrative and not restrictive, and the scope of the invention, therefore, is indicated by the appended claims rather than by the foregoing description. All changes which come within the meaning and range of equivalency of the claims are to be embraced within their scope.

What is claimed is:

1. An aerated confection comprising:
a. a texture modifier;
b. a saccharide mass, comprising:
i. a backbone saccharide with a first Tₘ;
ii. a stability saccharide with a second Tₘ; and
wherein the second Tₘ is greater than the first Tₘ.

2. The aerated confection of claim 1, wherein the aerated confection has an envelope density of less than or equal to 0.8 g/ml.

3. The aerated confection of claim 1, wherein the backbone saccharide has a T_{g} and further comprising a lubricant saccharide having a T_{g} less than the T_{g} of the backbone saccharide.

4. The aerated confection of claim 2, wherein the lubricant saccharide is up to about 20 wt. %.

5. The aerated confection of claim 1, further comprising up to about 20 wt. % of a non-saccharide lubricant.

6. The aerated confection of claim 4, wherein the non-saccharide lubricant is wax, fat, or combinations thereof.

7. The aerated confection of claim 1, further comprising additional ingredients selected from the group consisting of color, flavor, high intensity sweeteners, sensates, actives and combinations thereof.

8. The aerated confection of claim 1, wherein the confection contains less than 2 wt. % water.

9. The aerated confection of claim 1, wherein the texture modifier is about 3-35 wt. %.

10. The aerated confection of claim 1, wherein the saccharide mass is about 97-65 wt. %.

11. The aerated confection of claim 1, wherein the backbone is about 20-90 wt. % of the saccharide mass.

12. The aerated confection of claim 1, wherein the stability saccharide is about 80-10 wt. % of the saccharide mass.

13. An aerated confection of claim 1, wherein the backbone saccharide is selected from the group consisting of polydextrose, polyglycitol, corn syrup solids, and combinations thereof.

14. An aerated confection of claim 1, wherein the stability saccharide is selected from the group consisting of sucrose, dextrose, maltose, fructose, erythritol, mannitol, maltitol, isomalt, sorbitol, xylitol, and combinations thereof.

15. An aerated confection of claim 3, wherein the lubricant saccharide is selected from the group consisting of sucrose, dextrose, maltose, fructose, erythritol, mannitol, maltitol, isomalt, sorbitol, xylitol, and combinations thereof.

16. An aerated confection of claim 1, wherein the texture modifier is selected from the group comprising proteins, modified starches, maltodextrins, hydrocolloids, inulin, noncyrstallizing polyol solids and combination thereof.

17. An aerated confection of claim 1, further comprising dry powder ingredients, liquid ingredients, soft confectionery material, pan coating, or combinations thereof.

18. An aerated confection of claim 1, wherein the aerated confection is embossed or pressed.

19. The process for making an aerated confection, comprising the steps of:
a. introducing a confection mass containing a backbone saccharide, a stability saccharide, and a texture modifier, into a pressurized apparatus with mixing and heating capabilities;
b. mixing and heating confection mass in the apparatus to a temperature where all backbone saccharide is melted and fluid and little to no stability saccharide crystals are melted;
c. introducing super critical carbon dioxide into the extruder under high pressure conditions;
d. mixing the carbon dioxide into the confection mass;
e. forcing the confection mass with the carbon dioxide through an opening in the apparatus;
f. aerating the confection mass as it passes from the high temperature and pressure inside the apparatus to the ambient temperature atmospheric pressure outside the apparatus;
g. forming the aerated confection mass into a rope, ribbon, or sheet form as it passes out of the apparatus; and
h. shaping the aerated confection mass into individual pieces.

20. A process for making an aerated confection of claim 19, further comprising a finishing step for finishing the shaped confection pieces.

21. A process for making an aerated confection of claim 20, the finishing step including coating the expanded confection mass surface with dry powder ingredients, fluid ingredients, soft confectionery materials, pan coating, or combinations thereof.

22. A process for making an aerated confection of claim 20, the finishing step further comprising pressing, embossing, or combination thereof.

23. A process for making an aerated confection of claim 19, further comprising the addition into the apparatus before or after the confection mass is mixed with the carbon dioxide an ingredient selected from the group consisting of color, flavor, high intensity sweeteners, sensates, and combinations thereof.
